(19) United States
(12) Patent Application Publication
(10) Pub. No.: US 2025/0070488 A1
(43) Pub. Date: Feb. 27, 2025

(54) POWER CONTACT SUBASSEMBLY WITH EFFORTLESS COUPLING, POWER CONNECTION MODULE INTEGRATING SUCH A SUBASSEMBLY FOR CLAMPING AN ELECTRIC CABLE TERMINATION

(71) Applicant: RADIALL, AUBERVILLIERS (FR)

(72) Inventors: Patrice BECAVIN, AUZOUER EN TOURAINE (FR); Bastien DETILLEUL, Pessac (FR)

(21) Appl. No.: 18/945,075

(22) Filed: Nov. 12, 2024

(30) Foreign Application Priority Data
Nov. 16, 2023 (FR) 2312555

(51) Int. Cl. H01R 9/24

(52) U.S. Cl. CPC H01R 9/2416; H01R 9/2491

(57) ABSTRACT

Power contact subassembly with effortless coupling, Power connection module integrating such a subassembly for clamping an electric cable termination. The invention consists essentially of a subassembly with a power contact of female type formed by a socket comprising arms which are flexible and also in the form of petals that are at a sufficient spacing from one another to allow insertion, without mechanical effort, of a cylindrical male contact, a collar actuated by a displacement mechanism that deflects the flexible arms, which is to say clamps them on the latter to ensure electrical continuity, an elastic means exerting a force for holding the collar in the deflected position of the flexible arms and for clamping the male contact.

### TECHNICAL FIELD

The present invention relates to the field of electric power connectors.

More particularly, it relates to terminal block connection assemblies, and more particularly still to the power contacts implemented in these assembles.

Here and within the context of the present invention, a “terminal block” is understood to be a device for ensuring electrical continuity between a cable and another part of an installation. A terminal block, also known as connection terminal or screw terminal, is an electrically insulated module which fixes together two or more electric wires/cables intended to be electrically interconnected, and comprises an insulating support and at least one clamping component for fixing the wires/cables.

Here and within the context of the present invention, a “contact” is understood to be an element made of electrically conductive material for transmitting electrical current.

Although it is described with reference to a connection module for an electric cable termination in a terminal block, the invention can be implemented for any electric power connection that requires effortless coupling between power contacts while still ensuring a strong contact pressure once the coupling has been performed.

It is also the case that, although it is described with reference to a preferred application, that of aeronautics, and more particularly the wiring of aircraft, the invention may be implemented in any other application that requires a power connection between a lot of electric cables/wires in a junction area.

### BACKGROUND

One of the operations in the wiring of aircraft consists in electrically interconnecting a lot of electric power cables/wires.

This operation is usually implemented using a screw terminal block which is fixed to the structure of the aircraft and in which the plurality of electric cables/wires is inserted and then fixed by clamping.

FIGS. 1 and 2 show an example of such an existing terminal block, denoted overall by the reference 1, which is designed to connect two or more electric cables 2 fitted with lugs 20 at their ends by a screw/nut system.

This terminal block 1 firstly comprises an electrically insulating support 10 in which there are fixed terminal screws 11 that each form, with a nut 12, a screw/nut system for clamping the lugs 20 fitted to the cables 2.

An in particular electrically conductive washer 13, of the crinkle washer type, is provided for each screw/nut system.

Each terminal screw 11 passes through an electrically conductive bar 14. This bar 14 forms a bearing surface for the cable lugs 20 and thus forms an electric shunt between the cables 2 to be electrically connected. This plate 14 is optional and each screw 11 is electrically independent. As an alternative, the plate 14 may extend only over a partial length and electrically connect only some of the screws.

The support 10 is fixed to an aircraft structure S by column screws 15.

A cover 16 held by the column screws 15 forms a protective cover for the systems of screws and nuts 11, 12.

Since the terminal block 1 is not leaktight, an additional cover, commonly called an “umbrella”, is fixed to the structure of the aircraft, above the terminal block, to prevent condensed moisture from running off directly onto the cables 2 connected in the terminal block.

In addition to this non-leaktight aspect, such a screw terminal block 1 has numerous major drawbacks.

First of all, the lugs 20 have to be oriented perfectly in order to be threaded around the terminal screws 11 for a satisfactory electrical connection. More often than not, this means that an operator has to untwist the cables 2.

The number of components to be managed (screws, nuts, washers, shunt bar, cover, umbrella component) by an operator responsible for assembly is high and, in addition, there is a high risk of losing components, which therefore leads to the risk that a foreign object or mechanical debris can cause damage (FOD, which stands for “Foreign Object Damage”), the intention being definitively to avoid this in the field of aeronautics.

This risk of losing components is all the greater if the areas in which the existing terminal blocks 1 are fitted are difficult to access and/or have very restricted access and/or are in an awkward location for the operator. For example, the insulating support 10 is usually fixed on the ceiling in the structure of an aircraft. This can mean that the lugs installed on the screws 11 do not stay in place before also having fitted a nut 12. In other words, there is no function of preliminary holding in position of the lugs on the screws.

In addition to the intrinsic clamping operations by means of screws, which can take a long time for a dedicated operator, another operator is dedicated to systematically checking the clamping torques applied to fix the lugs 20 of the cables.

It is also the case that a screw terminal block requires the cables not to be powered on in order to avoid electrical risks for the operators responsible for the electrical connection. Moreover, these risks cannot be completely eliminated during tests for checking correct operation.

As a result, ultimately, it takes a long time to install a screw terminal block.

In addition, the lugs 20 can require a 180° orientation, this not being very compatible with power cables which are rigid, typically with a diameter of about AWG 000 (measurement unit “American Wire Gauge”), i.e. 10.4 mm.

Lastly, screw terminal blocks do not allow modularity, because the number of cables 2 that can be connected in just one and the same terminal block is fixed.

To improve the existing terminal blocks, the applicant's patent application EP3758165 proposed a connection assembly which makes it possible to add greater modularity, makes the installation easier, more particularly in areas with restricted access and/or for a lot of electric wires/cables to be connected, and makes it possible to protect the operators responsible for the connection against electrical risks.

Although this solution is completely satisfactory, there is still a need to improve terminal block assemblies, in particular for transmitting high currents, typically up to 400 A which involves a high contact pressure and therefore a high connection force, without premature wear of the contacts arising.

More generally, there is a need to propose a solution for coupling between power contacts that enables a high contact pressure and therefore a high connection force, without premature wear of the contacts arising.

The invention aims to meet this (these) need(s) in full or in part.

### SUMMARY

To this end, the invention relates, according to one of its aspects, to a power contact subassembly of the female type, comprising:
a female power contact in the form of a cylindrical socket, of central axis (X2), comprising:
   a hollow tube,
   flexible contact arms, which are in the continuation of the hollow tube and angularly distributed at a preferably regular spacing from one another and forming petals, the petals being designed to be deflected from a rest position in which a male power contact can be inserted between them, preferably effortlessly, to a deflected position in which the male power contact is clamped between the petals so as to establish electrical continuity between the male and female contacts;
a clamping collar, mounted slidingly around the socket for deflecting the arms;
a displacement mechanism of the collar for displacing the collar from a first position corresponding to the rest position of the petals to a second position corresponding to the deflected position of the petals, the displacement mechanism being designed to transform a pivoting movement, along an axis perpendicular to the central axis (X2) of the contact, of a separate component external to the collar into a translational movement of the collar;
an elastic position-return means for returning the collar from its first position to its second position.

In other words, the invention consists essentially of a subassembly with a power contact of female type formed by a socket comprising arms which are flexible and also in the form of petals that are at a sufficient spacing from one another to allow insertion, without mechanical effort, of a cylindrical male contact, a collar actuated by a displacement mechanism that deflects the flexible arms, which is to say clamps them on the latter to ensure electrical continuity, an elastic means exerting a force for holding the collar in the deflected position of the flexible arms and for clamping the male contact.

According to an advantageous embodiment, the displacement mechanism comprises:
a fork with at least one branch, mounted pivotably on the collar, with the free end of the branches bearing against an external stop,
a fork-pivoting lever or cam for causing the collar to translate from the first position to the second position, and vice versa.

Advantageously, the elastic return means is a helical compression spring mounted around the collar and the female power contact, with one of its longitudinal ends in abutment against an outer flange of the collar and the other of its longitudinal ends in abutment against an outer flange of the female power contact or against an external stop.

According to an advantageous embodiment, each petal end comprises an inwardly protruding locking surface designed to be accommodated in a peripheral recess of the male power contact in the deflected position of the petals and thus lock the axial displacement of the petals, preferably before or at the same time as the clamping of the male contact, the locking surface having a complementary shape to that of the peripheral recess of the male power contact.

As a result, the axial displacement of the petals of the female contact is locked by way of their inner surface which is accommodated, preferably with matching shapes, in the peripheral recess of the male contact.

According to an advantageous embodiment variant, the subassembly comprises an electrical insulator comprising:
a hollow tube accommodated inside the hollow tube of the female contact,
ribs that are in the continuation of the hollow tube and are angularly distributed at a preferably regular spacing from one another with delimitation of through-openings, each through-opening accommodating a petal of the female contact which protrudes outward at least in its rest position,
a ring, interconnecting the ribs, for mechanically protecting the front end of the petals.

The ribs make it possible both to guide and mechanically protect the arms of the female contact.

The invention also relates to an electrical connection module intended to form part of a terminal block of a connection assembly, of longitudinal axis (X) comprising:
at least one body made of electrically insulating material comprising at least one cavity which extends along the axis X and designed to accommodate an electric cable termination, comprising an electrically insulating sleeve and a preferably cylindrical, male power contact retained inside the sleeve, the contact being intended to be attached to, preferably crimped onto, an electric cable;
at least one subassembly as described above, fixed in the cavity with the petals of the female power contact designed to clamp, in their deflected position, the male contact of the electric termination.

Advantageously, the cavity accommodates a plate forming the external stop against which the other of the longitudinal ends of the helical spring is in abutment.

According to an advantageous embodiment, the displacement mechanism comprises:
an interface component which is intended for an external tool (H), is freely rotatably mounted in a receiving portion of the body and is designed to be made to rotate by the tool,
a pivoting cam secured to or formed integrally with the interface component, the rotation of the cam causing the fork to pivot orthogonally to the axis X, which makes the collar translate from the first position to the second position, and vice versa.

Advantageously, the interface component may comprise an interface recess for the tool, preferably a hexagonal socket recess.

According to an advantageous embodiment variant, the body of the module and/or the interface component comprise(s) at least one visual indicator arranged so as to be visible to an operator to indicate to them that the clamping position of the contact of the electric termination is correct. The body of the module and/or the interface component may thus comprise a noticeable area of color as visual indicator.

According to an advantageous embodiment, the body comprises an opening which is next to the cavity and is provided on the inside with a plurality of longitudinal straight grooves, preferably distributed regularly angularly, each designed to receive a straight spline formed around the sleeve of the electric cable termination.

The splines of the sleeve of the termination make it possible to react twisting forces of the cable on the body of the module. In addition, they make it possible to prevent the rotation of the contact by sliding, once it is clamped in the connection module.

By selecting small angular sectors between splines, an insertion of the contact in the module that does not need angular indexing is obtained.

According to another advantageous embodiment, the module comprises a part of a prelocking device, this part being designed to interact with another part of the prelocking device, this other part being secured to or formed integrally with the termination of the electric cable, for locking the male contact of the termination in its position accommodated in the cavity, before clamping by the petals of the female contact. A prelocking device ensures the insertion of the male contact in a correct position before the latter is clamped in the petals of the female contact.

According to this embodiment and a first implementation variant, the part of the prelocking device comprises at least one protuberance, formed on the outer periphery of a tubular continuation of the body of the module, the other part of the prelocking device comprising at least one lug, formed on the inner periphery of a collar mounted rotatably about the termination, the collar axially bearing against a part of the termination when the lug is in axial abutment against the rear of the protuberance to perform the prelocking.

According to this embodiment and a second implementation variant, the part of the prelocking device comprises a substantially U-shaped component slidingly mounted on a tubular continuation of the body of the module which is provided with two through-openings, the other part of the prelocking device comprising at least one recess, formed on the outer periphery of one part of the termination, the component being in a sliding position with the end of its branches forming ribs accommodated in the recess of the termination to perform the prelocking.

According to a first connection configuration, the female contact comprises a portion that extends out of the body and is designed to be electrically connected by welding or screwing to a busbar.

The electrical connection module may also be dedicated to a connection between harnesses, which is to say between at least two electric cable terminations, that are separate.

According to a second connection configuration, the module thus comprises:
two aligned or side-by-side bodies fixed to one another,
two electrically interconnected female contacts,
two displacement mechanisms independent of one another. It is thus possible to connect at least two electric cable terminations in series within one and the same module.

According to an advantageous design variant, the module comprises a single plate against which the other end of each of the two helical compression springs is in axial abutment.

According to another advantageous design variant, the two female contacts are screwed one in the other.

According to this second embodiment and a variant for connection between one current input and three outputs, it is provided in the module that:
each body comprises at least two aligned or non-aligned cavities, the cavities extending preferably parallel to the longitudinal axis (X) of the module,
the two female contacts of one and the same body are electrically interconnected, so as to produce an electric shunt between the at least four electric cable terminations when accommodated individually in the cavities.

The invention also relates to a terminal block connection assembly, comprising a plurality of modules of identical or different dimensions with cavities of identical or different dimensions for accommodating electric terminations of identical or different dimensions.

The invention lastly relates to a structure, in particular for an aircraft, comprising at least one electrical connection module as described above and/or at least one terminal block connection assembly as described above, preferably fixed on a rail support, which is itself intended to be fixed to the structure.

The invention has many advantages over the existing setup, including:
the elimination of problems of orienting the cables, which can be very rigid, by replacing the usual lugs with cylindrical contacts;
a reduction in the time needed to install the electric cables in a structure, in particular an aircraft structure, by way of a rapid assembly system which ensures effective clamping of the cable terminations, without requiring “torquing”, which is to say by applying a specific clamping force with a view to obtaining maximum precision;
individual coupling of each electric termination in a single- or multi-cavity connection module;
effortless coupling since, after clamping, the distance between the flexible arms (petals) of the female contact enables easy insertion of the male contact without friction, this moreover having the advantage of not causing wear of the contact and/or of any coating it might have;
as a result of the effortless coupling, an increase in the number of coupling cycles between male and female contacts, better resistance to corrosion, and the option of applying a less expensive surface coating to the contacts;
a high contact pressure between the electric contact of the cable termination and the flexible arms (petals) of the contact within the module, thereby reducing the electrical contact resistance and thus enabling a high current transmission with reduced heating;
reduction in the force exerted by an operator on the displacement mechanism, either directly or via a tool, making it possible to easily compress the elastic return element and therefore to use a particularly rigid elastic return element in order to obtain a significant clamping force on the flexible arms of the socket;
the option of a leaktight connection at the cavity of a module accommodating the contacts;
the option of indicating, both in visual terms (marking on the module in relation to an indicator on the interface component) and in sensory terms (mechanical stop of the termination contact), that the termination contact is clamped correctly in the module;
the elimination, in an aircraft structure, of existing umbrella components by virtue of the leaktight solution with connection modules that leaktightly accommodates the electric terminations in the cavities;
no risk of losing a component (FOD for “Foreign Object Damage”), since the solution according to the invention does not have independent, detachable components that need to be installed;
protection for the operators against electrical risks, because all they have to do now is directly manipulate the electrically insulating components (termination insulating sleeve and modules);
a high degree of modularity which can be easily adapted to various wiring configurations;
the connection module is particularly suitable for a high-voltage electric line (several hundred volts), since there is only a single potential in a connection module (phases and ground are separated in different modules) and the leakage and insulation paths between electrical conductors are longer.

The applications envisaged for a terminal block with modules according to the invention are numerous and include the wiring of civil aircraft.

Other advantages and features of the invention will become more clearly apparent upon reading the detailed description of exemplary embodiments of the invention, given by way of non-limiting illustration, and with reference to the following figures.

### BRIEF DESCRIPTION OF THE DRAWINGS

FIG. 1 shows a perspective view of an example of a screw terminal block according to the prior art used for electric wiring in the structures of an aircraft.

FIG. 2 is another perspective view of a screw terminal block according to the prior art showing cable harnesses with lugs connected in the terminal block.

FIG. 3 is a perspective view of a female power contact subassembly according to the invention.

FIG. 4 is an exploded view of FIG. 3.

FIG. 5 is a perspective view of a male power contact to be coupled to the female contact of the subassembly according to the invention.

FIG. 6A, FIG. 6B, FIG. 6C, FIGS. 6A, 6B and 6C are perspective views, in longitudinal section, showing the position of a male power contact respectively before it is inserted, before it is clamped once it has been inserted and after it has been clamped with locking within a female power contact subassembly according to the invention.

FIG. 7 is a perspective view of a connection module with two identical bodies that are fixed to one another and have aligned cavities each accommodating a subassembly according to the invention and a male contact of an electric cable termination coupled to the female contact of one of the subassemblies.

FIG. 8 is an exploded view of the module according to FIG. 7 with the two electric cable terminations.

FIG. 9A, FIG. 9B FIGS. 9A and 9B are cutaway views, in partial perspective, at the displacement mechanism of the collar of a subassembly within a module, showing respectively a position before insertion and clamping, and after insertion with clamping of the male contact of an electric cable termination.

FIG. 10A, FIG. 10B FIGS. 10A and 10B are cutaway views, from the side, at the displacement mechanism of the collar of a subassembly within a module, showing respectively a position after insertion and before clamping, and after clamping of the male contact of an electric cable termination.

FIG. 11A, FIG. 11B FIGS. 11A and 11B are views, in longitudinal section, at the male and female contacts within a module, corresponding respectively to FIGS. 10A and 10B.

FIG. 12 is a view, in longitudinal section, of a variant with sealing of a connection module according to the invention with two bodies that are fixed to one another and each accommodate a male contact of an electric cable termination and a female contact subassembly according to the invention.

FIG. 13 is a perspective view, in longitudinal section, of an embodiment variant of a female power contact according to the invention.

FIG. 14 is a perspective view of a first embodiment variant of a device for prelocking an electric cable termination in a subassembly according to the invention within a connection module.

FIG. 15 is a perspective view of a second embodiment variant of a device for prelocking an electric cable termination in a subassembly according to the invention within a connection module.

FIG. 16A, FIG. 16B FIG. 16C FIGS. 16A, 16B and 16C are perspective views showing the position of a male power contact respectively before it is inserted, before it is clamped and before it is prelocked with the variant of FIG. 15, once it has been inserted with rotational indexing, and after it has been clamped, prelocked and locked within a female power contact subassembly according to the invention.

FIG. 17 is a perspective view, in partial cutaway, of an embodiment of a connection module with two bodies each accommodating two adjacent cavities, which makes it possible to establish an electrical connection between one input electric cable termination and three output electrical cable terminations.

FIG. 18 is a perspective view, in partial cutaway, of an embodiment of a terminal block with multiple connection modules connected to one and the same busbar.

### DETAILED DESCRIPTION

Throughout the present application, the terms “vertical”, “lower”, “upper”, “bottom”, “top”, “below” and “above” are to be understood with respect to an electrical connection module in a fixed configuration, in particular fixed to a rail support, in a horizontal arrangement.

Similarly, the terms “internal” and “external” are to be understood with respect to a subassembly according to the invention, as integrated in a body of an electrical connection module.

Similarly, the terms “front” and “rear” are to be understood with respect to the connection end of an electric contact according to the invention. Thus, the front part of a female power contact of a subassembly according to the invention is that which is closest to the coupling part of a complementary male contact to the female contact, whereas the rear part is that which is furthest away.

For the sake of clarity, the same reference numeral is used for the same element of an electric cable according to the prior art and of an electric cable according to the invention.

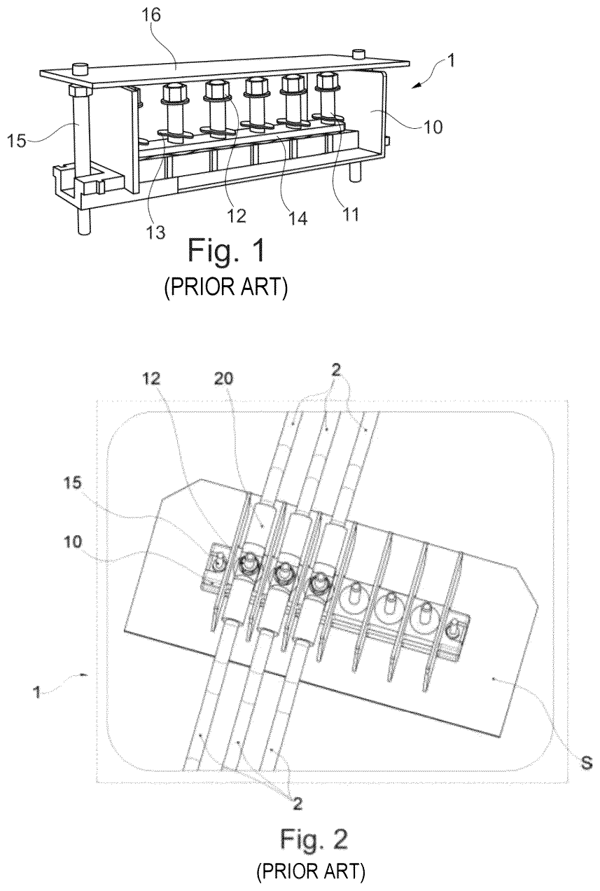

FIGS. 1 and 2 have already been described in detail in the preamble. They will therefore not be discussed below.

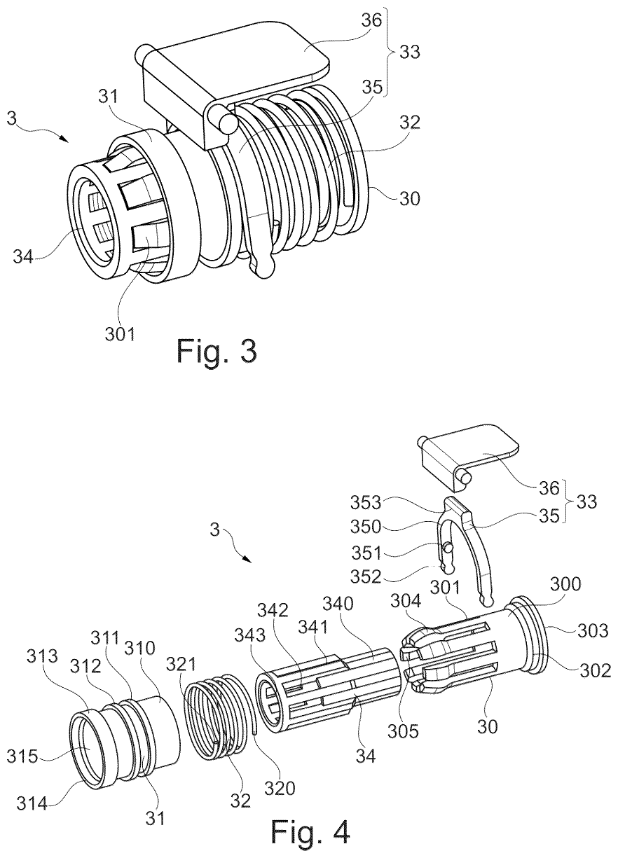

FIGS. 3 and 4 show an example of a power contact subassembly, denoted overall by the reference 3.

This subassembly 3 comprises a female power contact in the form of a cylindrical socket 30, which comprises a rear part in the form essentially of an at least partially hollow tube 300 and a front part in the form essentially of flexible contact arms 301 in the form of petals, which are in the continuation of the hollow tube 300 and are angularly distributed at a preferably regular spacing from one another with the formation of petals. In the example illustrated, the socket 30 comprises eight flexible arms 301 at a regular angular spacing.

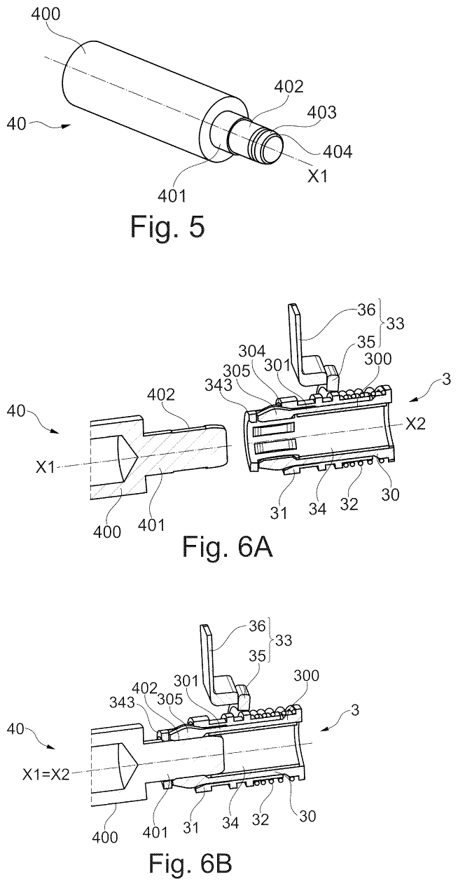

As set out in detail later on, the flexible arms 301 are designed to be deflected from a rest position, in which a male power contact 40, as illustrated in FIG. 5, can be inserted between them, preferably effortlessly, to a deflected position, in which the male power contact 40 is clamped between the flexible arms 301 so as to establish electrical continuity between the male and female contacts.

The subassembly 3 also comprises a clamping collar 31 mounted slidingly around the socket 30 for deflecting the arms 301.

A displacement mechanism 33 for the collar 31 makes it possible to displace the latter from a first position corresponding to the deflected position of the flexible arms to a second position corresponding to the rest position of the flexible arms.

The subassembly 3 lastly comprises a helical compression spring 32 which is mounted coaxially, preferably around the collar 31 and the female contact 30, and is an elastic position-return means for returning the collar from its second to its first position.

If appropriate, the subassembly 3 comprises an electrical insulator 34, which comprises a rear part in the form of a hollow tube 340 accommodated inside the hollow tube 300 of the female contact, and a front part in the form essentially of ribs 341 that are in the continuation of the hollow tube 300 and are angularly distributed at a preferably regular spacing from one another with delimitation of through-openings 342.

The ribs 341 make it possible both to guide and mechanically protect the arms/petals of the female contact.

Each through-opening 342 accommodates a petal 301 of the female contact that protrudes outward at least in its rest position.

The various components of the subassembly are described in more detail in an advantageous construction.

Besides the hollow tube 300, the rear part of the socket 30 comprises, in the continuation of the latter, an overthickness 302 and an outer flange 303. The overthickness 302 makes it possible to radially guide the helical spring 32. The outer flange 303 serves as a stop for the rear longitudinal end 320 of the spring 32.

Each end of a petal 301 comprises an external surface 304 which forms the surface of mechanical interference with the collar 31 and an internal surface 305, which forms a face of electrical contact with the male contact 40 and preferably a locking surface, protruding inward.

A cylindrical electric power contact 40 of the male type, of central axis X1, is shown in FIG. 5. It comprises a rear part 400 for crimping it to an electrical conductor of a cable and a front contact part 401, which has a smaller diameter than that of the rear part 400.

The front part 401 is preferably provided with a peripheral recess 402 which makes it possible to lock the axial displacement of the female contact 30 of the subassembly relative to the male contact 40.

The front part 401 also preferably comprises, in front of the peripheral recess, a chamfer 403 continuing, if appropriate, a shelf 404, which makes it possible to recenter the male contact 40 when it is being inserted into the female contact 30, and advantageously to reduce the insertion forces of the contact 40 by sliding on the chamfer 403/shelf 404.

The locking surface 305 of the petals 301 is designed to be accommodated in the peripheral recess 402 of the male power contact in the deflected position of the petals and thus lock the axial displacement of the petals, preferably before or at the same time as the clamping of the male contact.

With preference, the locking surface 305 has a complementary shape to that of the peripheral recess 402.

The locking collar 31 comprises a hollow tube 310 of which the outer surface is provided with three flanges 311, 312, 313 at a spacing from one another.

The rear flange 311 serves as a stop for the front longitudinal end 321 of the spring 32 and as bearing for the pivot stud 351 of the actuating mechanism, described below.

The intermediate flange 312 serves as bearing for an element of the actuating mechanism.

The front flange 313 makes it possible to create an inner chamfer 314 continued by an inner clearance 315. The inner chamfer 314 makes it possible to inwardly deflect the arms/petals 301 of the female contact 30 during the displacement of the collar 31. The inner clearance makes it possible to reduce the mechanical stresses.

The electrical insulator 34 may comprise a ring 343, interconnecting the ribs 341, for mechanically protecting the front end of the petals 301 and stiffening the ribs 341 of the electrical insulator.

As illustrated in FIGS. 3 and 4, the displacement mechanism 33 may comprise:
a fork 35 with at least one branch 350, two branches in the example illustrated, mounted pivotably on the collar 31, with the free end of the branches bearing against an external stop,
a fork-pivoting lever 36 for causing the collar 31 to translate from the first position to the second position, and vice versa.

In particular, a pivot stud 351 on the inside of one of the branches 350 may pivotably bear against the flanges 311 and 312 of the collar 31.

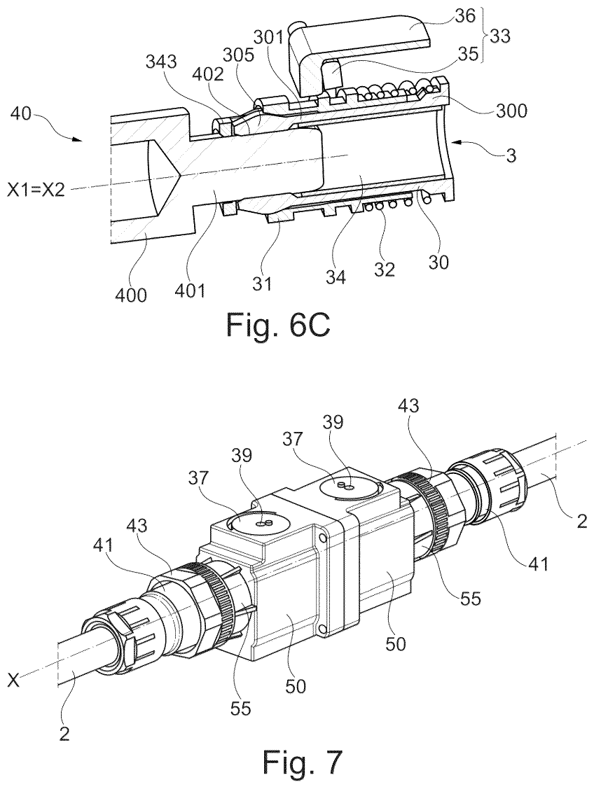

A description will now be given, with reference to FIGS. 6A to 6C, of a method for inserting, coupling and locking a male contact 40 in a contact subassembly 3, as have just been described.

It is specified that, before step a/, the lever 36 has been actuated, which is to say that it has been rotated so as to transition from a horizontal position to a vertical position. This rotation of the lever 36 has made the fork 35 pivot backward, causing the spring 32 to be compressed and the collar 31 to pull back. The pulling back of the collar brings the flexible arms (petals) 301 into a rest position. The female contact 30 is then ready to be coupled to a male contact 40.

Step a/: As illustrated in FIG. 6A, the male contact 40 is moved up to the female contact 30 with alignment of their central axes X1, X2. The displacement mechanism 33 is actuated: the lever 36 is thus in an outwardly deployed position. The collar 31 is in a rearwardly pulled-back position. The spring 32 is in its compressed state between the female contact 30 and the collar 31. In this configuration, the petals 301 of the female contact 30 are in a rest, i.e. non-deflected position.

Step b/: As illustrated in FIG. 6B, the male contact 40 is inserted freely, which is to say effortlessly, into the female contact 30 with their central axes X1, X2 coincident. The displacement mechanism 33 is actuated: the lever 36 is thus in an outwardly deployed position. The collar 31 is still in its position pulled back to the rear. The spring 32 is still in its compressed state between the female contact 30 and the collar 31. In this configuration, the petals 301 of the female contact 30 are in a rest, i.e. non-deflected position.

Step c/: As illustrated in FIG. 6C, the male contact 40 is inserted into the female contact 30 with their central axes X1, X2 coincident. The displacement mechanism 33 has been released and is no longer actuated: the lever 36 is thus in an inwardly turned-down position. The fork 35 is inclined to the front of the contact with an angular pivoting range limited by the flange 312. Consequently, the collar 31 is in its forwardly advanced position. The spring 32 is in its expanded state between the female contact 30 and the collar 31. In this configuration, the petals 301 of the female contact 30 are in their deflected position and clamp the male contact, and are kept in this position by the spring 32. More specifically, the inner surface 305 of the petals 301 is accommodated and in abutment, with a clamping force, in the peripheral recess 402 of the male contact 40. The male contact 40 and female contact 30 are thus mutually coupled and locked.

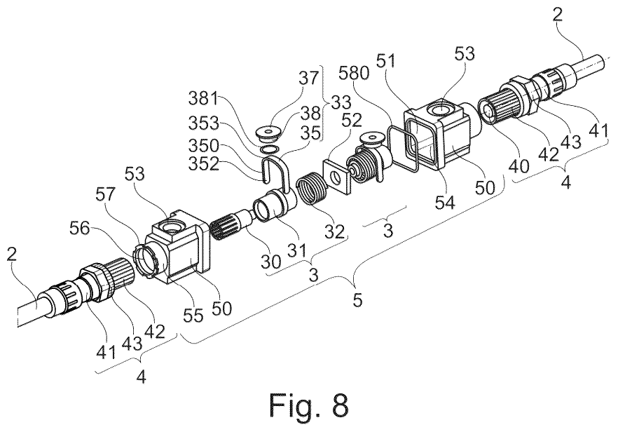

FIGS. 7 and 8 illustrate an electrical connection module 5 according to the invention, intended to form part of a terminal block of a connection assembly, which integrates two female contact subassemblies 3 according to the invention. This module 5 makes it possible to establish an electrical connection between an input termination 4 of an electric cable 2 and another, output termination.

This electrical connection module 5 comprises two preferably identical bodies 50 fixed to one another. The means for fixing between the two bodies 50 are not shown but may be screws/nuts passing all the way through the body.

Each body 50 is electrically insulating, of longitudinal axis X, and is intended to accommodate, clamp and lock and connect at least one termination 4 of an electric cable 2.

More specifically, each body 50 comprises a cavity 51 within it and the two cavities 51, which are preferably the same size, face one another; in each of these cavities a termination 4 of an electric cable 2 is inserted, clamped and locked, as explained below.

An electric cable termination 4, of central axis X1, comprises an electrically insulating sleeve 41 and a cylindrical electric contact 40 crimped onto an electric cable 2 and inserted and fixed, in particular by snap-fastening, inside the sleeve 41.

On its outer periphery, the sleeve 41 comprises straight splines 42 which extend around the central axis X1 over some of the length of the sleeve.

The cylindrical contact 40 is identical to that described with reference to FIG. 5.

In addition, the electric cable termination 4 comprises a prelocking collar 43, which is mounted rotatably about the sleeve 41 and the function of which will be described below.

In each cavity 51 is fixed a female contact subassembly 3 as described with reference to FIGS. 3 and 4, except that:
the displacement lever 36 of the displacement mechanism 33 is replaced by an interface component 37 for an external tool H and a displacement cam 38 secured to or formed integrally with the component 37,
the longitudinal end 320 of the spring 32 is in abutment against a plate 52 fixed within a module body 50.

More specifically, the interface component 37 for a tool H is freely rotatably mounted in a receiving portion 53 of the body and is designed to be made to rotate by the tool. The interface component 37 may comprise an interface recess 39 for the tool, preferably a hexagonal socket recess. A operator can thus use a conventional tool, such as a hexagon key.

The bridge 353 of the fork 35 bears against the pivoting cam 38 and the free end 352 of the branches 350 of the fork bears against a stop 54 internal to the body 50.

In the embodiment illustrated, there is a single plate 52 for forming the stop for the two springs 32 on either side. Each subassembly 3 has an independent actuating mechanism 37, 38.

Furthermore, as shown, the body 50 comprises a tubular continuation 55 with an opening 56 facing the cavity 51.

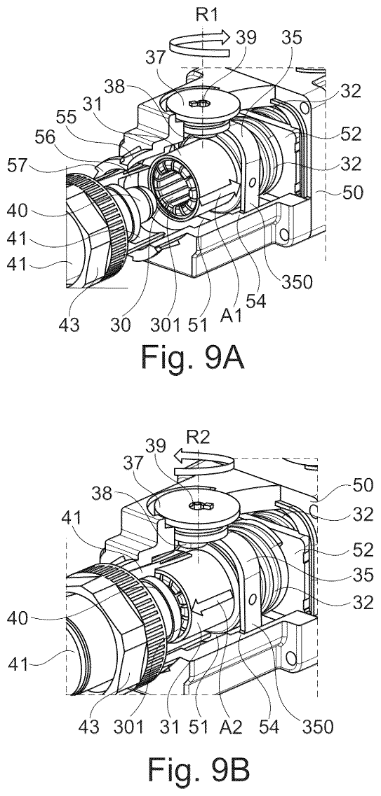

A description will now be given, with reference to FIGS. 9A to 11B, of a method for inserting, coupling and locking a male contact 40 of a termination 4 of a cable 2 in a connection module 5 with contact subassemblies 3, as have just been described.

Step a1/: As illustrated in FIG. 9A, before or during the insertion of the male contact 40 with its sleeve 41 into the opening 56, the interface component 37 and therefore the displacement cam 38 are made to rotate about the arrow R1, thereby causing the fork 35 to pivot about its pivot point 351 on the collar 31 and into abutment against the stop 54 of the body 50 and thus the collar 31 to pull back along the arrow A1 and the spring 32 to be compressed. The spring 32 is therefore in its compressed state between the plate 52 and the collar 31. The rotation of the cam 38 makes it possible to reduce the force exerted by the operator on the interface component 37, and thus to easily compress the spring 32. In this configuration, the petals 301 of the female contact 30 are in a rest, i.e. non-deflected position.

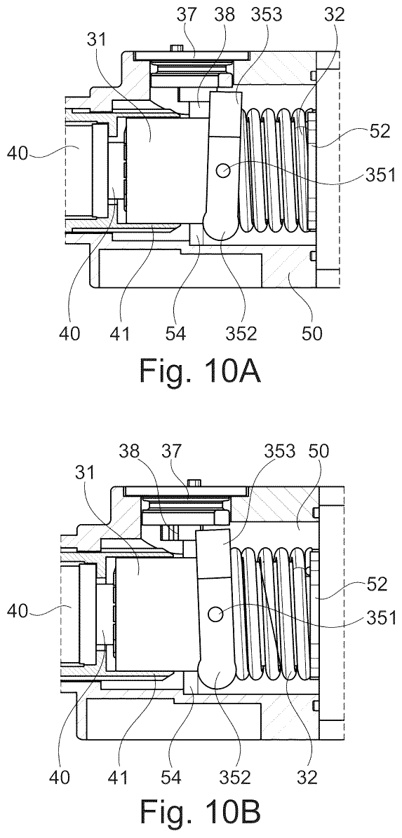

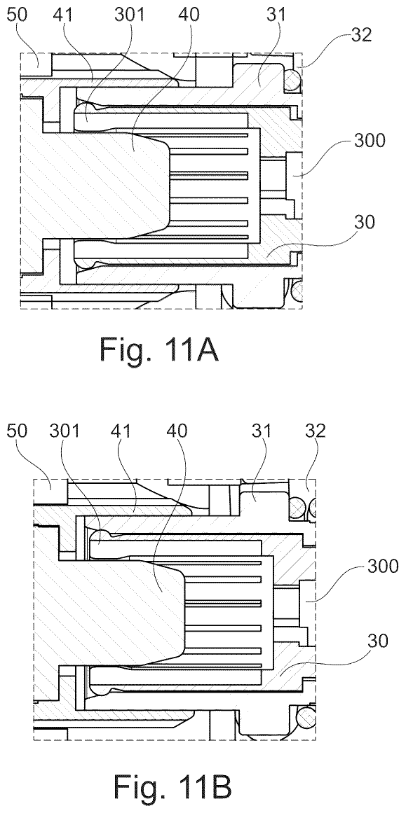

Step b1/: The male contact 40 with its sleeve 41 is inserted into the opening 56. The male contact 40 is inserted freely and without mechanical effort between the petals 301 of the female contact 30. The spring 32 is still in its compressed state between the plate 52 and the collar 31. The collar 31 is still in its position pulled back to the rear. In this configuration, the petals 301 of the female contact 30 are still in the rest, i.e. non-deflected position (FIGS. 10A, 11A). The sleeve 41 is force-fitted, also without mechanical effort, around the collar 31.

Step c1/: As illustrated in FIGS. 9B, 10B, 11B, the male contact 40 is inserted into the female contact 30. The interface component 37 and therefore the displacement cam 38 are made to rotate about the arrow R2, in the opposite direction to R1, thereby causing the fork 35 to pivot into abutment against the stop 54 of the body 50 and thereby the collar 31 to be pulled forward along the arrow A2, in the opposite direction to A1, and the spring 32 to be expanded. The spring 32 is therefore in its expanded state between the plate 52 and the collar 31.

In this configuration, the flexible arms 301 of the female contact 30 are in a deflected position. The spring 32 exerts a holding force on the collar in this position. The male contact 40 and female contact 30 are thus mutually coupled and locked.

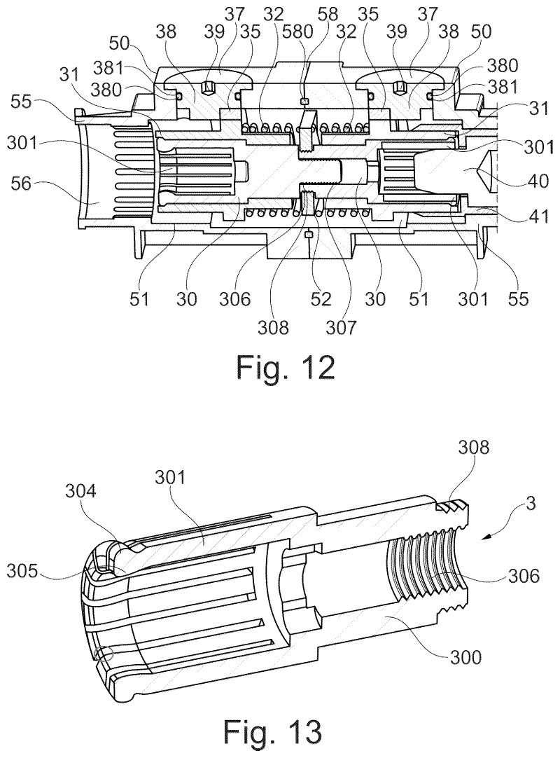

FIG. 12 shows advantageous design variants of the module 5 that has just been described, which make it possible to obtain a more compact and more robust module that also has very good electrical continuity.

The stop plate 52 for the springs 32 is sandwiched between the two bodies 50 of the module.

The two female contacts 40 are in this case screwed one in the other. It is also the case that one of the female contacts 40 (that on the right in FIG. 12) is screwed directly in the stop plate 52.

To do this as shown in FIG. 13, the tubular part 300 of one of the contacts 30 has a thread 306 tapped on the inside for interacting with a threaded shank 307 of the other one of the contacts. The internally tapped tubular part 300 also has a thread 308 made on the outside which is screwed directly into the plate 52.

According to an additional embodiment, it is possible to provide a prelocking function for a male contact 40 in a body 50 of a module 5, which is realized once the contact 40 has been inserted but before the rotation of the cam 38 with the collar 31 which deflects the petals 301 of the female contact 30. Advantageously, this prelocking function can be realized by an operator using just one hand. This prelocking makes it possible to ensure the correct axial positioning of the male contact in the female contact, before the two contacts are clamped and coupled.

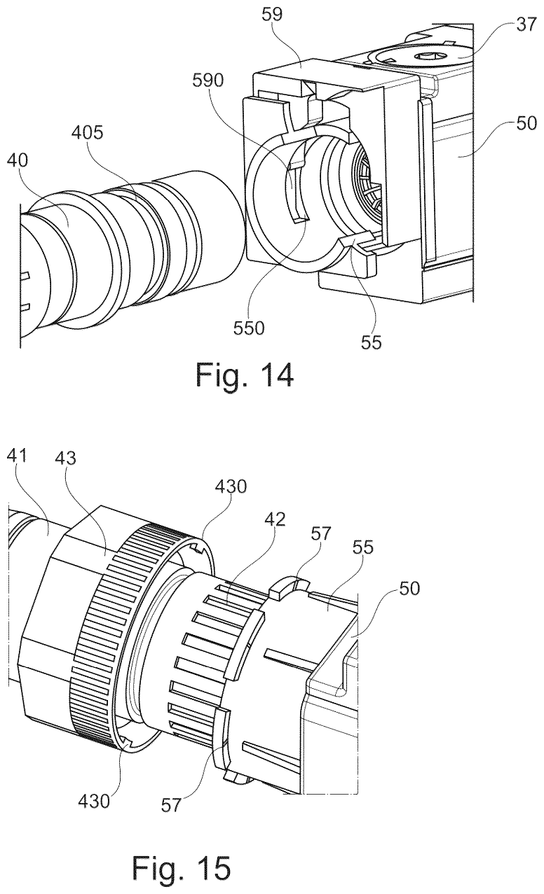

A first variant of a prelocking device is shown in FIG. 14. A substantially U-shaped component 59, the ends of the branches 590 of which form ribs, is mounted slidingly on the tubular continuation 55 of the body 50 of the module. The tubular continuation 55 is provided with two through-openings 550 in each of which a rib 590 can be inserted. Once the contact 40 has been inserted in the body 50 of the module, the component 59 is made to slide such that the end of its ribs 590 is accommodated in an outer recess 405, provided for this, of the sleeve 41. The contact 40 is thus prevented from translating in the body 50 and it is thus prelocked. If the male contact 40 is not axially positioned correctly, it is impossible to make the component 59 slide, and this indicates in visual and in sensory terms that the contact 40 has been incorrectly installed.

A second variant of a prelocking device is shown in FIG. 15. At least one protuberance 57, preferably a plurality, is formed on the outer periphery of the tubular continuation 55 of the body 50 of the module 5. A collar 43 mounted rotatably about the sleeve 41 of the termination 4 comprises at least one lug 430 formed on its inner periphery. Once the contact 40 has been inserted into the body 50 of the module, the collar axially bears against a part of the termination and the lug 430 is in axial abutment against the rear of the protuberance 57. The contact 40 is thus prevented from translating in the body 50 and it is thus prelocked.

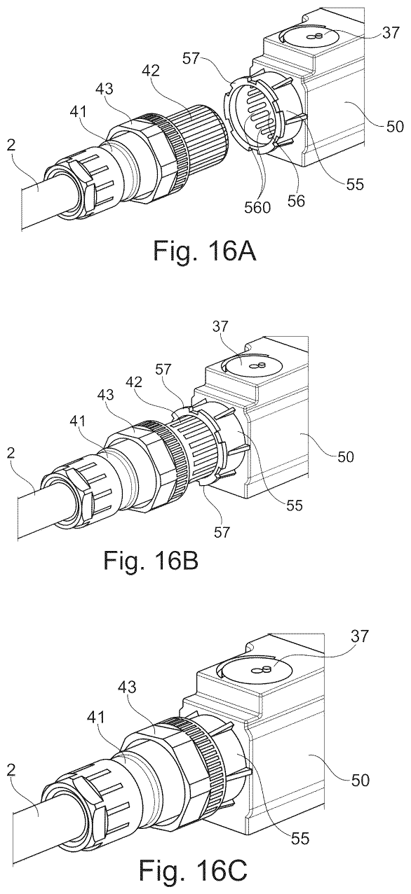

As shown in detail in FIGS. 16A to 16C, it is possible to produce a part of the module body 50 and an electric cable termination 4 so as to prevent the latter from rotating once its contact has been inserted into a cavity 51.

The opening 56 of the body next to the cavity 51 is thus provided on the inside with a plurality of longitudinal straight grooves 560, preferably distributed regularly angularly, each designed to receive a straight spline 42 formed around the sleeve 40 of the electric cable termination.

The splines 42 make it possible to react twisting forces exerted by the cable 2 on the body of the module 3 and also prevent the rotation of the contact 40 by sliding, once it has been inserted and clamped in the connection module 5.

The splines 42 are preferably at a small angular spacing from one another, thereby allowing the contact 40 to be inserted into the body 50 of the module without having to rotationally index it beforehand.

The prelocking collar 43 can be installed once the rotation of the contact 40 is prevented by the splines 42 (FIG. 16C).

Furthermore, it is possible to envisage a leaktight variant of the connection between the one or more contacts 40 of the termination 4 and the one or more module bodies 50.

As shown in FIG. 8, this variant may for example consist in installing at least one annular grommet mounted in the end of the sleeve 41 at the interface with the cable 2.

As shown in FIG. 12, it is also possible to provide an O ring 580 at the interface 58 between two bodies 50 fixed to one another.

In addition, it is possible to provide an O ring 381 arranged around the interface component 38, in its receiving portion 380 (FIG. 12).

The connection modules according to the invention enable various configurations for connecting electric harnesses with electric cable terminations 4.

As described and illustrated above, one and the same module 5 may comprise two preferably identical, mutually facing bodies 50 fixed to one another. This enables an electrical connection with a single input and output.

Other configurations with multiple outputs are possible.

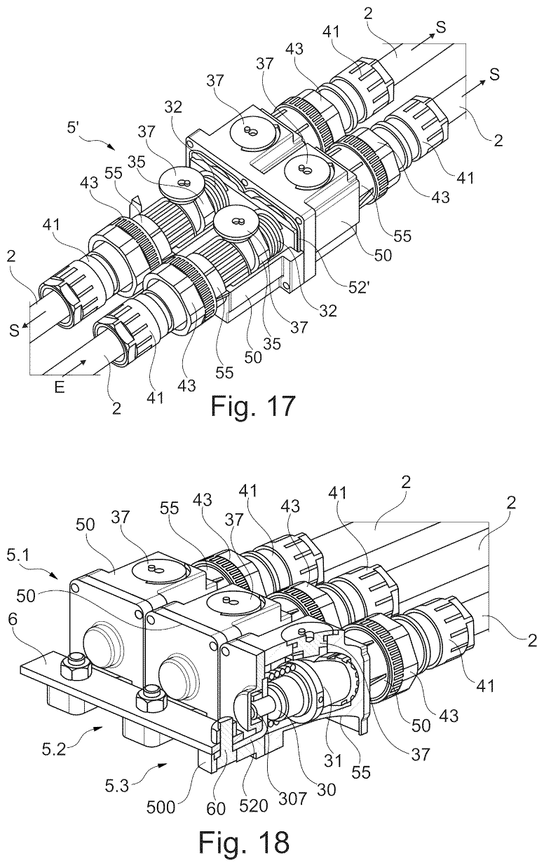

FIG. 17 illustrates a variant having one electrical input E and three electrical outputs S with an electric shunt formed inside the body 50 of a connection module 5′.

More specifically, as shown in this FIG. 17, the module 5′ comprises two aligned bodies 50 fixed to one another, each of the bodies 50 on the inside comprising two cavities 51 extending parallel to the longitudinal axis (X) of the module.

As an alternative, the two bodies may be positioned side by side and fixed to one another.

Each contact 30 is clamped by means of a displacement mechanism 37, 38 independent of the others. The electric shunt is formed by a single plate 52′ electrically connected to the four female contacts 30.

Another possible configuration with connection modules according to the invention is a connection with multiple terminations 4 of electric cables 2 to a busbar or connection bar.

Such a configuration is illustrated in FIG. 18 with three preferably identical modules 5.1, 5.2, 5.3 arranged parallel to one another. In this configuration illustrated, each body 50 of the modules comprises a single cavity 51 in which a contact 40 of a termination 4 of an electric cable 2 is inserted and clamped.

A stop plate 52 comprises an extension portion 520 which extends out of the body 50.

Each body 50 comprises a continuation 500 which has the shape of a right parallelepiped and supports an extension portion 520 of the stop plate 52.

The female contact 30 comprises a shank 307 screwed in the stop plate 52.

The parallel electrical connection between the various female contacts 30 and therefore between the electric terminations 4 is realized by a common busbar 6 which is fixed by means of a screw/nut 60 in the extension portion 520 of each stop plate 52. It is possible of course to envisage, instead of the screws/nuts 60, a fixation to the busbar by welding.

Other variants and improvements may be provided without thereby departing from the scope of the invention.

It is possible to provide modules of different dimensions with a different number of cavities for accommodating electric cable terminations 4 of different sizes.

It is also possible to provide a fixation and locking of a connection module in a rail support. Although in the example illustrated of the variant for preventing rotation of the termination, the longitudinal straight grooves are made in the body and the complementary straight splines are borne by the sleeve, it is also possible of course to envisage the reverse case, which is to say with the splines formed in the body and the sleeve being provided on its periphery with longitudinal straight grooves.

The expression “having a” is to be understood as synonymous with “having at least one”. unless indicated otherwise.

1. A power contact subassembly of the female type, comprising:
a female power contact in the form of a cylindrical socket of central axis, comprising:
a hollow tube,
flexible contact arms, which are in the continuation of the hollow tube and angularly distributed with the formation of petals, the petals being designed to be deflected from a rest position in which a male power contact can be inserted between them, to a deflected position in which the male power contact is clamped between the petals so as to establish electrical continuity between the male and female contacts;
a clamping collar, mounted slidingly around the socket for deflecting the arms;
a displacement mechanism of the clamping collar for displacing the clamping collar from a first position corresponding to the deflected position of the petals to a second position corresponding to the rest position of the petals; the displacement mechanism being designed to transform a pivoting movement, along an axis perpendicular to the central axis of the contact, of a separate component external to the collar into a translational movement of the clamping collar;
at least one elastic position-return means for returning the clamping collar from its second position to its first position.

2. The subassembly as claimed in claim 1, the displacement mechanism comprising:
a branched fork mounted pivotably on the clamping collar, with the free end of the branches bearing against an external stop,
a fork-pivoting lever or cam for causing the clamping collar to translate from the first position to the second position, and vice versa.

3. The subassembly as claimed in claim 1, the elastic return means being a helical compression spring mounted around the clamping collar and the female power contact, with one of its longitudinal ends in abutment against an outer flange of the clamping collar and the other of its longitudinal ends in abutment against an outer flange of the female power contact or against an external stop.

4. The subassembly as claimed in claim 1, each petal end comprising an inwardly protruding locking surface designed to be accommodated in a peripheral recess of the male power contact in the deflected position of the petals and thus lock the axial displacement of the petals, the locking surface having a complementary shape to that of the peripheral recess of the male power contact.

5. The subassembly as claimed in claim 1, comprising an electrical insulator comprising:
a hollow tube accommodated inside the hollow tube of the female contact,
ribs that are in the continuation of the hollow tube and angularly distributed with delimitation of through-openings, each through-opening accommodating a petal of the female contact which protrudes outward at least in its rest position,
a ring, interconnecting the ribs, for mechanically protecting the front end of the petals.

6. An electrical connection module intended to form part of a terminal block of a connection assembly, of longitudinal axis comprising:
at least one body made of electrically insulating material comprising at least one cavity which extends along the axis X and is designed to accommodate an electric cable termination, comprising an electrically insulating sleeve and a male power contact retained inside the sleeve, the male power contact being intended to be attached to an electric cable;
at least one subassembly as claimed in claim 1, fixed in the cavity with the petals of the female power contact designed to clamp, in their deflected position, the male power contact of the electric termination.

7. The electrical connection module as claimed in claim 6, the cavity accommodating a plate forming the external stop against which the other of the longitudinal ends of the helical spring is in abutment.

8. The electrical connection module as claimed in claim 6, the displacement mechanism comprising:
an interface component which is intended for an external tool, is freely rotatably mounted in a receiving portion of the body and is designed to be made to rotate by the tool,
a pivoting cam secured to or formed integrally with the interface component, the rotation of the cam causing the fork to pivot orthogonally to the axis X, which makes the collar translate from the first position to the second position, and vice versa.

9. The electrical connection module as claimed in one of claim 6, the body comprising an opening which is next to the cavity and is provided on the inside with a plurality of longitudinal straight grooves, each designed to receive a straight spline formed around the sleeve of the electric cable termination.

10. The electrical connection module as claimed in claim 6, comprising a part of a prelocking device, this part being designed to interact with another part of the prelocking device, this other part being secured to or formed integrally with the termination of the electric cable, for locking the male power contact of the termination in its position accommodated in the cavity, before clamping by the petals of the female contact.

11. The electrical connection module as claimed in claim 10, the part of the prelocking device comprising at least one protuberance, formed on the outer periphery of a tubular continuation of the body of the module, the other part of the prelocking device comprising at least one lug, formed on the inner periphery of a collar mounted rotatably about the termination, the collar axially bearing against a part of the termination when the lug is in axial abutment against the rear of the protuberance to perform the prelocking.

12. The electrical connection module as claimed in claim 10, the part of the prelocking device comprising a substantially U-shaped component slidingly mounted on a tubular continuation of the body of the module which is provided with two through-openings, the other part of the prelocking device comprising at least one recess, formed on the outer periphery of one part of the termination, the component being in a sliding position with the end of its branches forming ribs accommodated in the recess of the termination to perform the prelocking.

13. The electrical connection module as claimed in claim 6, the female contact comprising a portion that extends out of the body and is designed to be electrically connected by welding or screwing to a busbar.

14. The electrical connection module as claimed in claim 7, comprising:
two aligned or side-by-side bodies fixed to one another,
two electrically interconnected female contacts,
two displacement mechanisms independent of one another.

15. The electrical connection module as claimed in claim 14, comprising a single plate against which the other end of each of the two helical compression springs is in axial abutment.

16. The electrical connection module as claimed in claim 14, the two female contacts being screwed one in the other.

17. The electrical connection module as claimed in claim 14, in which:
each body comprises at least two aligned or non-aligned cavities,
the two female contacts of one and the same body are electrically interconnected, so as to produce an electric shunt between the at least four electric cable terminations when accommodated individually in the cavities.

18. A terminal block connection assembly, comprising a plurality of electrical connection modules as claimed in claim 6, of identical or different dimensions with cavities of identical or different dimensions for accommodating electric terminations of identical or different dimensions.

19. A structure, in particular for an aircraft, comprising at least one electrical connection module as claimed in claim 6 and/or at least one terminal block connection assembly as claimed in claim 18 which is itself intended to be fixed to the structure.
